(19) United States
(12) Patent Application Publication
(10) Pub. No.: US 2007/0155426 A1
(43) Pub. Date: Jul. 5, 2007

(54) Application access to cellular telephone settings

(76) Inventors: Govind Balakrishnan, Foster City, CA (US); Angus Davis, Pleasant Hill, CA (US); Chris Thilgen, San Francisco, CA (US)

Correspondence Address: FULBRIGHT & JAWORSKI, LLP (ADOBE), 2200 ROSS AVENUE, SUITE 2800, DALLAS, TX, 75201-2784, US

(21) Appl. No.: 11/323,477

(22) Filed: Dec. 31, 2005

(51) Int. Cl. H04H 7/00; H04M 1/00

(52) U.S. Cl. 455/556.2; 455/3.06

(57) ABSTRACT

In an embodiment, a method is presented. The method includes presenting a user interface to a user on a cellular telephone by operating a media player with a content file. The method also includes receiving user commands. The method further includes translating the user commands to device specific commands in the media player responsive to the content file.

### BACKGROUND

Cellular telephones have steadily advanced in terms of processor power and associated resources such as memory. Cellular telephones have correspondingly moved from primitive user interfaces and operating systems to more advanced software. However, the basic telephone operations such as dialing and receiving calls have not involved a similar advance.

The operating system of the cellular telephone (“cellphone”) is typically coded by the cellphone manufacturer as a cellphone specific operating system. This cellphone specific operating system exposes fundamental controls, such as user input and output controls, to applications executing on the cellphone. The applications run the gamut from games to calendaring services to web browsers. However, phone-specific and telephone book controls are not accessible to and/or are ignored by applications developers. As a result, phone-specific functions including the telephone book interface are implemented within the operating system—in a part of the basic operating system dedicated to the phone-specific functions. Such functions have often been ignored by developers.

Thus, under the current system, a media player such as FLASH media player available from Macromedia may not be used to initiate phone calls, access information from a cellular phone database (e.g. names or phone numbers), or receive calls, for example. The only telephone interface available is that supplied by the cell phone manufacturer as part of the operating system. This means that the telephone interface must be designed into the operating system at the beginning of the development cycle, and must be implemented within the software language used to implement the operating system. As will be appreciated, this implies that software coders skilled in operating system implementation will be responsible for the interface rather than creative designers often responsible for developing user interfaces. Having the telephone interface “frozen” within the cellphone operating system also tends to preclude easy updates, third-party customization, and rapid prototyping, among other capabilities.

Additionally, cell phone operating systems have historically limited access to functions as basic as memory storage or event handling. Thus, it may be useful to provide a user interface which may be developed separately from the operating system. Additionally, it may be useful to provide storage for state data in a media player or similar application. Moreover, it may be useful to handle events within a user interface separate from the operating system.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In an embodiment, a method is presented. The method includes presenting a user interface to a user on a cellular telephone by operating a media player with a content file. The method also includes receiving user commands. The method further includes translating the user commands to device specific commands in the media player responsive to the content file.

In another embodiment, a system is presented. The system includes a cellular telephone. The cellular telephone includes a processor, a display coupled to the processor, and a network interface coupled to the processor. The cellular telephone also includes a local storage medium coupled to the processor. A media player is embodied in the local storage medium. An operating system is also embodied in the local storage medium. A user interface is embodied as a content file for the media player in the local storage medium. The user interface receives commands from a user. The media player translates the commands from the user into commands to the cellular telephone.

In yet another embodiment, a method is presented. The method includes presenting a user interface to a user on a cellular telephone by operating a media player with a content file. Additionally, the method includes receiving user commands. Moreover, the method includes translating the user commands to device specific commands in the media player responsive to the content file. Also, the method includes accessing a function of the cellular telephone responsive to a user command. Further, the method includes accessing local information of the cellular telephone responsive to a user command and storing local information.

In addition to the exemplary aspects and embodiments described above, further aspects and embodiments will become apparent by reference to the drawings and by study of the following descriptions.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a personal device such as a cellular telephone.

FIG. 2 illustrates an embodiment of a process of operating a user interface on a personal device.

FIG. 3 illustrates an embodiment of a process of handling software on a personal device.

FIG. 4 illustrates another embodiment of a process of handling software on a personal device.

FIG. 5 illustrates an embodiment of a machine-readable medium.

FIG. 6 illustrates an embodiment of a user interface as illustrated in hierarchical form.

FIG. 7 illustrates an embodiment of a network.

FIG. 8 illustrates an embodiment of a personal device.

FIG. 9 illustrates an embodiment of a process of designing a graphical user interface.

FIG. 10 illustrates an alternate embodiment of a process of designing a graphical user interface.

FIG. 11 illustrates an alternate embodiment of a process of operating a user interface on a personal device.

FIG. 12A illustrates an embodiment of a user interface which may be used with a variety of embodiments of cellular telephones.

FIG. 12B illustrates an embodiment of a cellular telephone and software running on the device.

FIG. 13 illustrates an embodiment of a process of updating a user interface based on a content file.

FIG. 14 illustrates an embodiment of a process of interrupting a media player on a cellular telephone.

FIG. 15 illustrates an embodiment of a process of retrieving data and setting data on a cellular telephone.

FIG. 16 illustrates an embodiment of a process of setting a function key on a cellular telephone.

### DETAILED DESCRIPTION

A method and apparatus for application access to mobile device settings is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

In various embodiments, a personal device is provided in which dedicated operating system functions are exposed for use by other software. For example, telephone functions such as dialing a call or answering a call are exposed for use by other software. Such functions may be executed responsive to a user interface other than the operating system interface of the personal device, allowing for extensive customization and extension of user interface software and capabilities.

The specific embodiments described in this document represent exemplary instances of the present invention, and are illustrative in nature rather than restrictive in terms of the scope of the present invention. The scope of the invention is defined by the claims. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, the invention is a method. The method includes providing an operating system on a cellular telephone. The method also includes providing a graphical display engine on the cellular telephone. The method further includes providing a user interface having a plurality of hierarchical interface layers. At least one of the plurality hierarchical interface layers is provided by the graphical display engine. At least one of the plurality of hierarchical interface layers is provided by the operating system.

In another embodiment, the invention is a mobile telephone. The telephone includes a processor and an inboard memory coupled to the processor. Also, the telephone includes a radio frequency interface coupled to the processor. Moreover, the telephone includes a user input device and a user output device coupled to the processor. Similarly, the telephone includes a user audio input and a user audio output coupled to the processor. The telephone also includes a phone operating system module including a predefined user interface embodied in the inboard memory. The telephone further includes a separate graphical user interface module embodied in the inboard memory.

In still another embodiment, the invention is a mobile device having a plurality of hierarchical interface layers. The mobile device includes a computer and an operating system controlling the computer. A multimedia player and a content file are also included. At least one level of the plurality of hierarchical interface layers is provided by the operating system, and at least another level of the plurality of hierarchical interface layers is provided by the multimedia player operating on the content file.

In a further embodiment, the invention is a combination. The combination includes a personal device. The personal device includes a processor. The personal device also includes a memory, a user input device and a user output device coupled to the processor. The personal device includes an operating system module including a predefined user interface embodied in the memory. The personal device also includes a separate graphical user interface module embodied in the memory.

In yet another embodiment, the invention is a method. The method includes receiving a command from a user. Also, the method includes determining whether the command is supported by either a phone operating system or a separate graphical user interface. Moreover, the method includes executing the command with the separate graphical user interface if the command is supported by the separate graphical user interface. Similarly, the method includes passing the command to the phone operating system if the command is not supported by the separate graphical user interface and executing the command with the phone operating system if the command is not supported by the separate graphical user interface.

In a still further embodiment, the invention is a mobile telephone. The mobile telephone includes a processor. The mobile telephone also includes an inboard memory, a radio frequency interface, a user input device and a user output device coupled to the processor. Similarly, the mobile telephone includes a user audio input and a user audio output coupled to the processor. The mobile telephone further includes a phone operating system module including a predefined user interface embodied in the inboard memory. Moreover, the mobile telephone includes a FLASH player module embodied in the inboard memory. The FLASH player module is configured through a script to provide a user interface when executed by the processor, with the user interface configured to access phone functions.

In an embodiment, a method is presented. The method includes presenting a user interface to a user on a cellular telephone by operating a media player with a content file. The method also includes receiving user commands. The method further includes translating the user commands to device specific commands in the media player responsive to the content file.

In another embodiment, a system is presented. The system includes a cellular telephone. The cellular telephone includes a processor, a display coupled to the processor, and a network interface coupled to the processor. The cellular telephone also includes a local storage medium coupled to the processor. A media player is embodied in the local storage medium. An operating system is also embodied in the local storage medium. A user interface is embodied as a content file for the media player in the local storage medium. The user interface receives commands from a user. The media player translates the commands from the user into commands to the cellular telephone.

In yet another embodiment, a method is presented. The method includes presenting a user interface to a user on a cellular telephone by operating a media player with a content file. Additionally, the method includes receiving user commands. Moreover, the method includes translating the user commands to device specific commands in the media player responsive to the content file. Also, the method includes accessing a function of the cellular telephone responsive to a user command. Further, the method includes accessing local information of the cellular telephone responsive to a user command and storing local information.

In an embodiment, a method is presented. The method includes receiving specifications for a cellular telephone. The method further includes developing a platform independent user interface implemented by a media player for a cellular telephone separately from an operating system for the cellular telephone. The method also includes integrating the user interface with the operating system.

In another embodiment, a system is presented. The system includes a cellular telephone. The cellular telephone includes a processor. The cellular telephone also includes a display coupled to the processor and a network interface coupled to the processor. The cellular telephone further includes a local storage medium coupled to the processor. A media player and an operating system are embodied in the local storage medium. A user interface is embodied as a content file for the media player in the local storage medium.

In still another embodiment, a method is presented. The method includes developing an operating system for a cellular telephone. The method further includes separately developing a platform independent user interface implemented by a media player for a cellular telephone. The method further includes integrating the user interface with the operating system.

In an embodiment, a method is presented. The method includes providing a user interface content file. Additionally, the method includes playing the user interface content file in a media player on a cellular telephone. Moreover, the method includes interacting with a user using the user interface content file. Additionally, the method includes downloading an update to the user interface content file.

In yet another embodiment, a system is presented. The system includes a cellular telephone. The cellular telephone includes a display coupled to the processor, a network interface coupled to the processor and a local storage medium coupled to the processor. A media player is embodied in the local storage medium. The media player is to play content in a content file to produce a software-based user interface. The media player is also to update the content file responsive to availability of new updates.

In still another embodiment, a method is presented. The method includes providing a user interface content file. The method also includes playing the user interface content file in a media player on a cellular telephone. The method further includes interacting with a user using the user interface content file. The method includes receiving notification of the update to the user interface content file. The method additionally includes finding the update to the user interface content file. The method also includes downloading an update to the user interface content file. The method further includes installing the update to the user interface content file.

In an embodiment, a method is presented. The method includes playing a content file on a media player of a cellular telephone to provide a user interface to a user of the cellular telephone. The content file is independent of the cellular telephone. The method also includes receiving user commands through the user interface. The method further includes operating the cellular telephone responsive to the user commands.

In yet another embodiment, a system is presented. The system includes a cellular telephone. The cellular telephone includes a processor and a display coupled to the processor. The cellular telephone further includes a network interface coupled to the processor and a local storage medium coupled to the processor. An operating system and a media player are embodied in the local storage medium. A user interface is embodied as a content file for the media player in the local storage medium. The user interface is to receive commands from a user. The user interface is standard across a set of cellular telephone models.

In another embodiment, a method is presented. The method includes receiving a command from a user in a user interface. The user interface is produced by a media player playing a content file on a cellular telephone. Also, the method includes detecting support for the command within the user interface produced by the media player playing the content file on the cellular telephone. Further, the method includes handling the command from the user in a manner responsive to detecting support for the command.

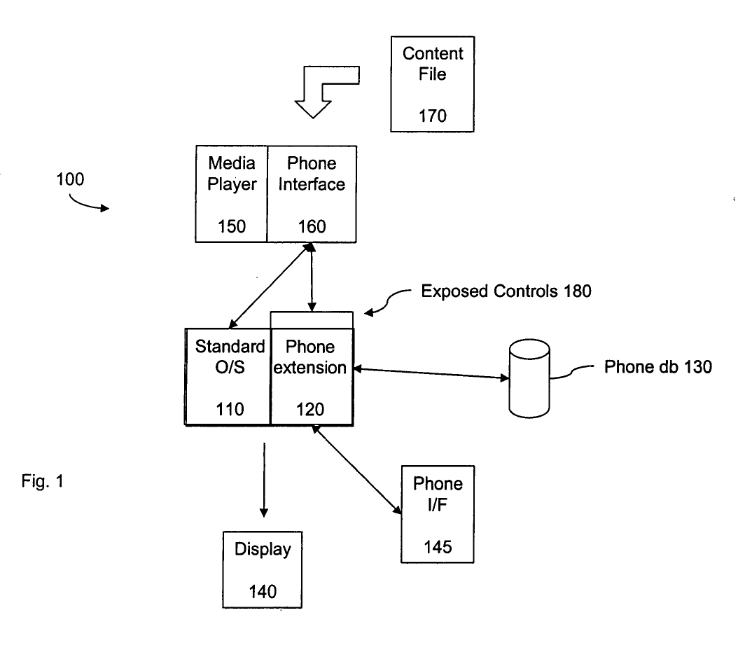

Illustration and description of various embodiments may provide more insight. FIG. 1 illustrates an embodiment of a personal device such as a cellular telephone. Device 100 may be one of a variety of devices, such as a cellular telephone, two-way pager, personal digital assistant, or other device, and may incorporate features of more than one such device, for example. Device 100 is illustrated from the point of view of functional modules (some software, some hardware) or units and related communications.

Standard operating system 110 is an operating system for the device 100, which implements basic operating system commands such as reading and writing memory or storage, and managing components such as display 140. Phone extension 120 is a portion of OS 110 which is dedicated to cellular phone functions such as dialing a call, receiving a call, ignoring a call, checking for voicemail on a network, or checking for signal strength/connectivity for example. Note that in other devices, phone extension 120 may be implemented as a pager extension or a similar portion of an operating system for the device, for example. Also, note that phone extension 120 may implement both user-initiated commands such as initiating a call and system-initiated commands such as receiving a call.

Phone extension 120 interacts with phone database 130, allowing for storage of telephone numbers and names, access of stored information, and phone operations (e.g. dialing, caller identification) based on such information. Database 130 may be a classic database with a SQL interface, for example, or may be organized in alternative ways, such as in a flat file or stored array of information for example. Interacting with the OS 110 and potentially with phone extension 120 is display 140, which displays user information and may accept user input as well. Phone interface 145 may similarly be expected to interact with phone extension 120 and potentially directly with OS 110, to implement connectivity with a network such as a cellular network, for example. Phone extension 120 and OS 110 are typically developed along with development of phone hardware of device 100, resulting in an operating system closely tied to capabilities of the device 100. This also results in a system difficult to update or change, as OS 110 and phone extension 120 are likely to be stored in persistent memory as executable code, requiring extensive testing, compiling and editing of source code to produce modules 110 and 120.

Also present is media player 150, which may be implemented as a module such as software which runs in conjunction with OS 110. Media player 150 may also implement phone interface 160, a portion or module appropriate for accessing phone controls of a cellular telephone through exposed controls 180. Exposed controls 180 may be expected to be controls or primitives exposed by phone extension 120 to allow for control of phone functions without requiring the phone extension 120 to control the user interface of device 100. Thus, exposed controls 180 may allow for access to phone database 130, initiation of calls or reception of calls through phone interface 145, or other use of phone-specific commands.

Media player 150 may be software such as a FLASH media player available from Macromedia of San Francisco, Calif. Such media players typically use a content file 170 as a script to direct execution and thereby implement a graphical user interface, for example. Thus, content file 170 may provide a script which includes user commands for initiating a phone call or receiving a phone call, and media player 150 may implement phone interface 160 based on content file 170 to execute those commands without presenting to the user the graphical user interface implemented by phone extension 120. This, in turn, allows for extension and transformation of the graphical user interface experienced by an end user, based on the overlaid media player 150 and associated content file 170. Moreover, due to the content file 170, changes in a user interface may be implemented rapidly by updating content file 170.

Using such a structure potentially provides a number of advantages. For example, the user interface may be designed by a graphic designer using design tools, rather than a programmer using C code—potentially allowing for more desirable look and feel. Additionally, user interface development may be separated from development of the operating system. Moreover, update of the user interface depends on update of the content file, allowing for update through over-the-air programming or other similar methods, for example. Also, user interfaces can be developed in a device-independent manner.

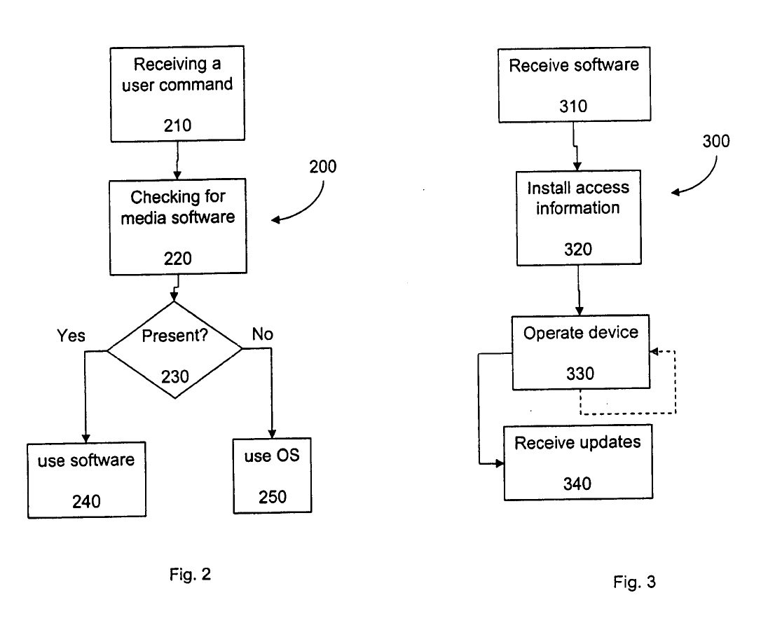

User interfaces for devices may operate in various ways. FIG. 2 illustrates an embodiment of a process of operating a user interface on a personal device. Process 200 and other processes of this document are implemented as a set of modules, which may be process modules or operations, software modules with associated functions or effects, hardware modules designed to fulfill the process operations, or some combination of the various types of modules, for example. The modules of process 200 and other processes described herein may be rearranged, such as in a parallel or serial fashion, and may be reordered, combined, or subdivided in various embodiments. Process 200 includes receiving a user command, determining whether media software is present, and using either the media software or the operating system to execute the user command.

Process 200 begins at module 210, with receipt of a user command, such as a request to dial a phone number, receive a phone call, or look up information stored in a phone, for example. The process checks for media software such as a media player at module 220. At module 230, the process determines if the media software is present. If the media software is present, at module 240 the software is used to execute the command. If the media software is not present, at module 250 the phone OS is used to execute the command.

Software on a personal device may be handled in a variety of ways, allowing for various methods of installation, update, and maintenance. FIG. 3 illustrates an embodiment of a process of handling software on a personal device. Process 300 relates to installing and updating software on a personal device such as a cellular telephone. Process 300 includes receiving software, installing the software and associated access information, operating the device, and receiving updates to the software on the device.

Process 300 initiates at module 310 with receipt of software for installation on the personal device, such as receipt of a media player software module or modules for example. The software is installed, including installation of interface or access information at module 320. At module 330, the personal device is operated, such as through normal user use. At module 340, updates to the software are received. Such updates may include revised software or revised scripts for software in embodiments where the software uses scripts. Thus, updates may involve complex changes (software) or simpler changes (scripts). The process moves to module 320 to install the update and appropriate access information, whether a software interface and software or a script and a location of the script.

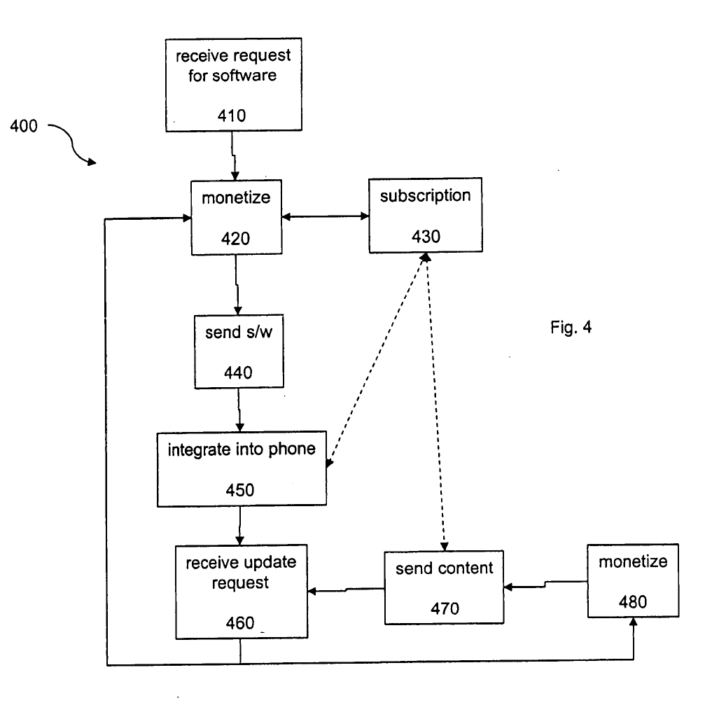

Software may be handled (installed or operated) on a personal device in other ways, too. FIG. 4 illustrates another embodiment of a process of handling software on a personal device. Process 400 includes receiving a request for software, monetizing the request, sending the software, integrating the software into the phone, receiving an update request, monetizing the update request, and sending the update. Process 400 may also interact with a subscription process or module.

Process 400 initiates at module 400, with receipt of a request for software. Such a request may be transmitted over a network, for example. The request is monetized at module 420, such as by charging for the software on a one-time basis, adding a charge to a regular invoice (such as a telephone bill), or by arranging for a subscription that may be managed by subscription module 430, for example.

The software is then sent to the phone or personal device, such as over a network or through a connection to another machine. At module 450, the software is integrated into the phone or personal device, such as through installation of the software. Integration into the phone may include checking for a current subscription with subscription management module 430, for example. At some point thereafter, a request for an update to the software is received at module 460. This may involve either an update to actual software, or an update to content used by the software. If content is to be updated, at module 480 the transaction is monetized, and at module 470 the content is sent to the phone/personal device (and integrated into the phone such as by saving the content on the phone/device). Note that rather than outright monetization, checking with a subscription management module 430 may be sufficient. If actual software is to be updated, the process moves to module 430.

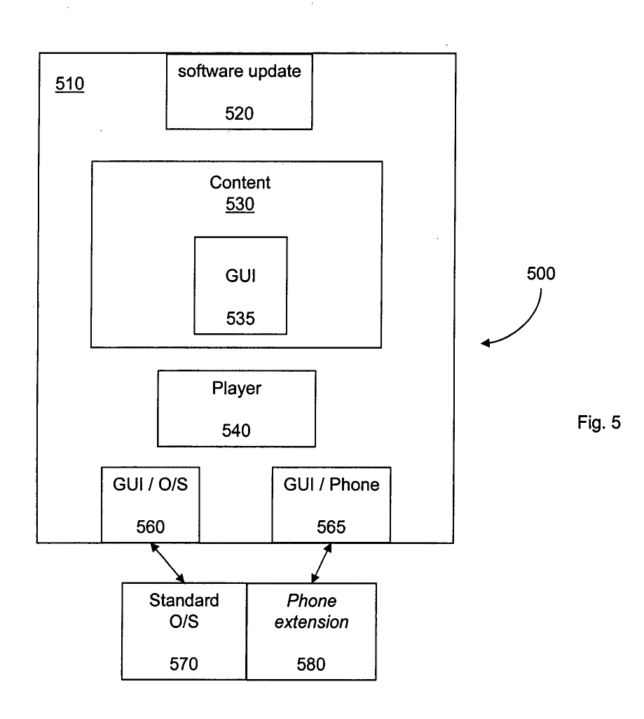

The various processes and related processes may be implemented by a personal device in response to instructions embodied in a medium. FIG. 5 illustrates an embodiment of a machine-readable medium. System 500 includes medium 510 and modules which may be accessed by the modules embodied in medium 510. Medium 510 includes a media player, associated content, interfaces with operating systems, and an update module.

A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals and digital signals). Such machine-readable media may embody computer programs as a result of storing a set of instructions, which, when executed by a processor, cause the processor to perform a method.

Media player 550 may take various forms, and is typically a module which plays content files as a visual or visual and audio presentation on a personal device. Exemplary of media player 550 is Flash media player available from Macromedia in San Francisco, Calif. Content module 530 is illustrative of content which may be included with a media player 550 or distributed separately. Content module 530 may be embodied as a file or some other data repository. As illustrated, it includes a graphical user interface file 535. Media player 550 may play the file(s) of content module 530 to produce a graphical user interface on a phone or other personal device.

Operation on a personal device is likely to require interaction with the operating system(s). Therefore, GUI/OS interface 560 and GUI/Phone interface 565 are supplied. Through interfaces 560 and 565, messages or commands may be passed back and forth between player 550 on one side, and standard operating system 570 and phone extension 580 on the other side. Note that two separate interfaces are shown, but interfaces 560 and 565 may be combined as a single interface, with interface 565 used to interact with exposed phone functions, for example.

Additionally, the software and content of medium 510 may be updated at times. Software update module 520 provides an interface for updating either the software (player 550) or the content (content 530) in whole or in part. Thus, software update module 520 may download software or content, install the downloaded data, and enable the updated system to operate. Moreover, software update module 520 may also use subscription and payment data to either authenticate a user or device as having paid for updates, or to complete a transaction to pay for updates as necessary.

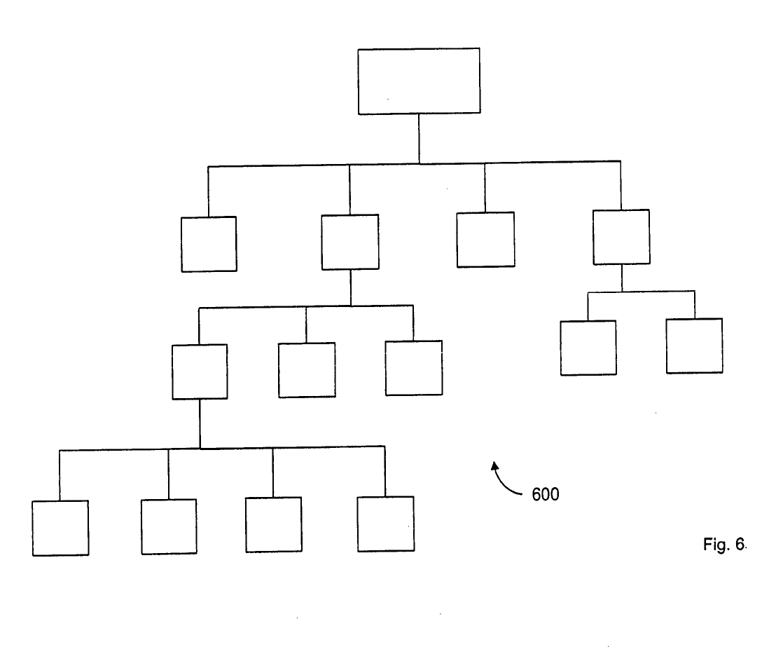

With software present, a user interface may be displayed or implemented. FIG. 6 illustrates an embodiment of a user interface as illustrated in hierarchical form. Interface 600 is exemplary of a menu hierarchy of an interface. A first level is provided with a set of menu choices. From those menu choices, a second level of the hierarchy is accessed, in some instances to execute a command and in other instances to access a submenu and corresponding hierarchy. As illustrated, two menu choices lead to a second level of the hierarchy. Of those two parts of the second level of the hierarchy, one has a menu choice in a submenu that leads to a third level of the hierarchy and further submenu choices.

Such a structure may be encoded as part of a phone operating system, making it static once the phone is shipped. Changes in such operating systems are expensive, requiring software updates that must be tested extensively, potentially across a wide variety of platforms. However, structure 600 may also be implemented by a media player using a content file on a phone. In such an instance, changing the content file would effectively change the structure 600, allowing for changes without the need for compilation and potentially decreasing the need for widespread testing. Content files can be replaced without causing problems throughout an operating system, and can easily be customized or personalized compared to an operating system. Moreover, if a content file attempts to fix one problem, and fails, one may revert to the previous content file and continue living with the one problem. If an operating system release attempts to fix a myriad number of identified bugs, but breaks other functionality, going back may be expensive or otherwise difficult.

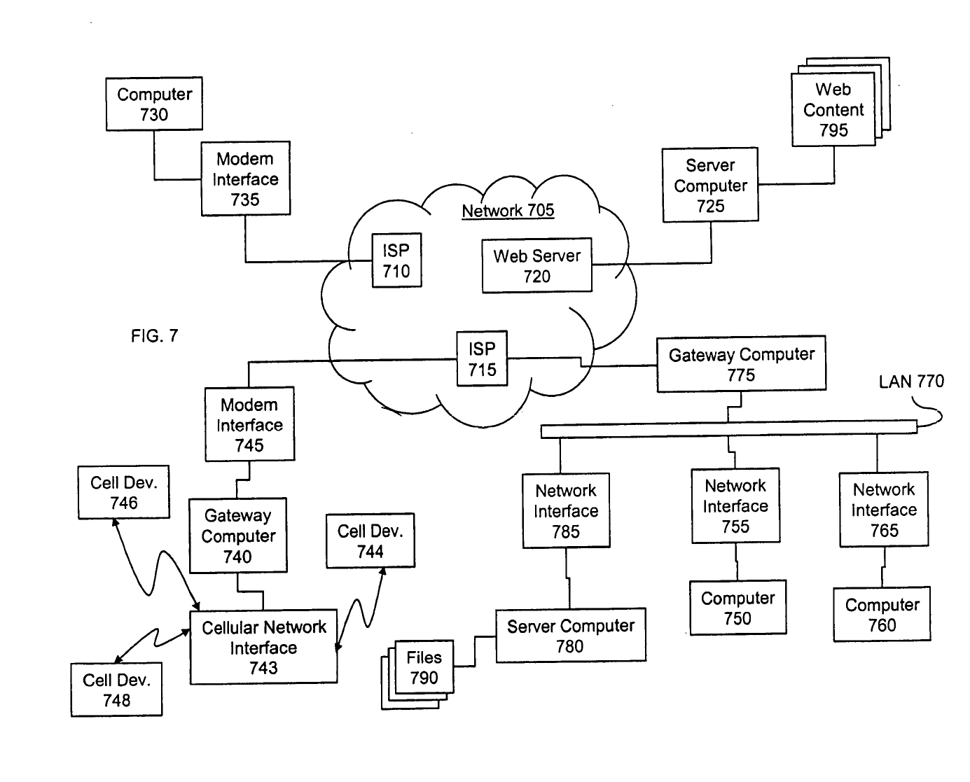

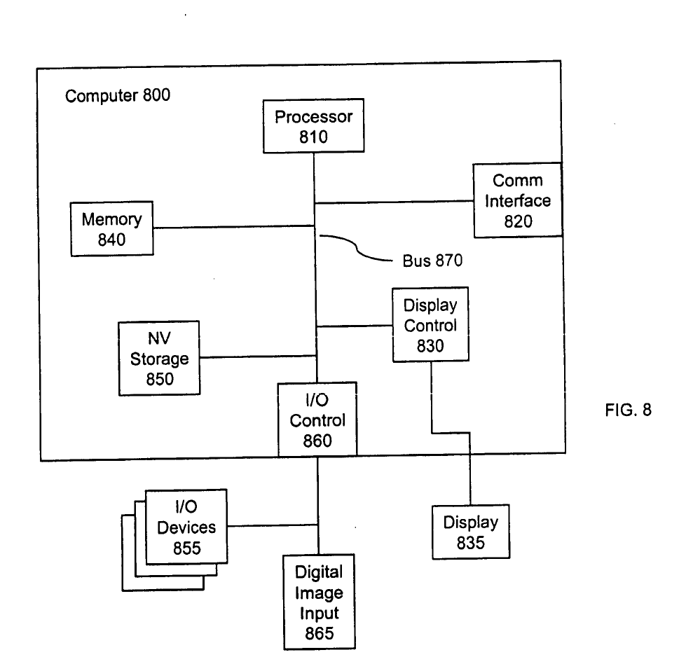

The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular network and related cellular devices. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example. Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device. Such a device can be used to perform many functions depending on implementation, such as telephone communications, two-way pager communications, personal organizing, or similar functions. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the two types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/i-o controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

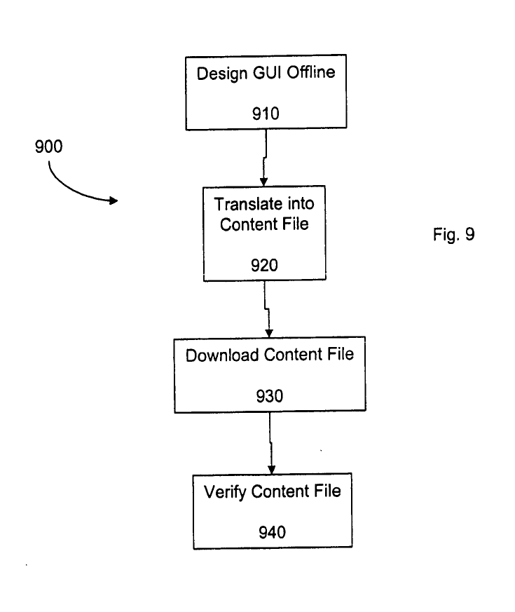

While the various structures and implementations of the graphical user interface have already been described, it may also help to illustrate how a graphical user interface may be designed. FIG. 9 illustrates an embodiment of a process of designing a graphical user interface. Process 900 includes designing the GUI, translating the GUI into a content file, downloading the content file and verifying the content file.

Initially, the GUI is designed offline at module 910. This allows one to use high-power tools on a personal computer platform, for example, while simulating the environment of a personal device. At module 920, the GUI is translated into a content file. This may occur during design in module 910, or separately, depending on implementation preferences. The content file is then downloaded to a subject personal device at module 930. Verification of the content file at module 940 then occurs. This may involve simply verifying the content file was correctly received, or may also involve verifying functionality of the content file (testing/debugging). Because this is a content file, one may expect that most aspects of it will work properly, otherwise the content file would not have been generated at module 920.

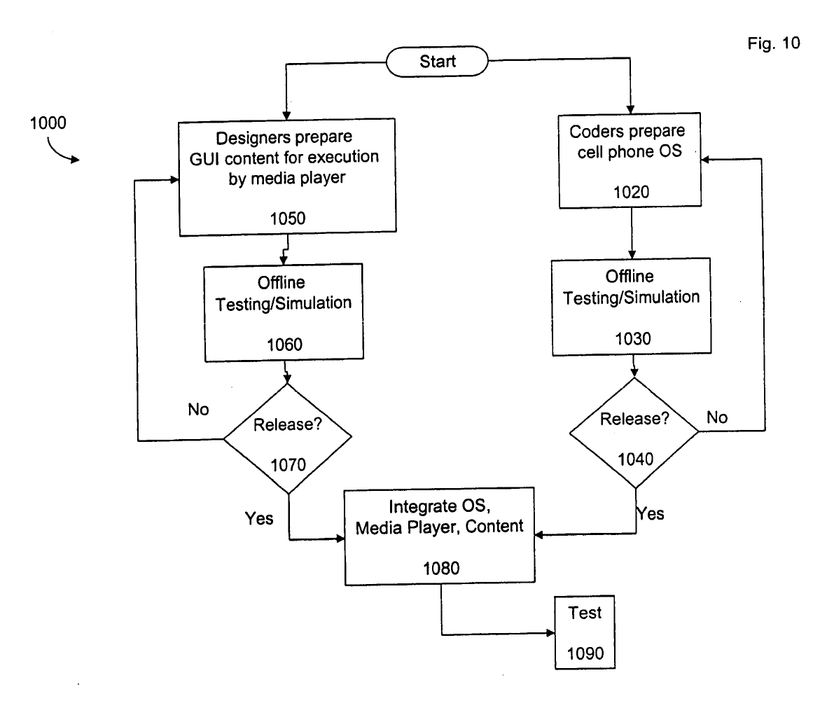

Understanding development of both a content file and a operating system may also help. FIG. 10 illustrates an alternate embodiment of a process of designing a graphical user interface. Process 1000 includes parallel tracks involving designing and testing an operating system and a content file, release of the resulting designs, integration and testing of the combination.

Process 1000 initiates at module 1010. At module 1020, programmers (coders) prepare the cell phone operating system, including coding various modules, testing those modules, and integrating those modules. At module 1030, the integrated operating system is tested and simulated, resulting in additional evaluation of the operating system modules operating as a whole, and potential feedback to various programmers, or changes in the entire system. At module 1040, a decision is made as to whether to release the operating system. If the operating system may be released, then production of the phone or personal device may proceed, whereas if it is not ready, production must wait for another round of coding and testing.

In parallel, at module 1050, designers prepare a GUI by preparing content for execution or play by a media player. This preparation involves specifying appearances of items which are to be displayed, specifying animation of the interface, and otherwise determining the look and feel of the interface. At module 1060, the interface is tested, resulting in feedback on whether the desired look and feel was achieved, along with feedback on whether the content file requires technical capabilities beyond those of the personal device. At module 1070, a determination is made as to whether the content file provides a GUI which is suitable for release. If not, designers go back to work at module 1050, if so then the content and the operating system are integrated at module 1080.

Integration involves putting the operating system and the media player and content file into a personal device. At module 1090, the personal device is tested. If testing results in the personal device locking up or otherwise failing to perform, this may be debugged, typically resulting in recoding of parts of the operating system. If testing results in the device functioning but appearing different from what is desired, this may be corrected either by correcting content or the operating system as needed.

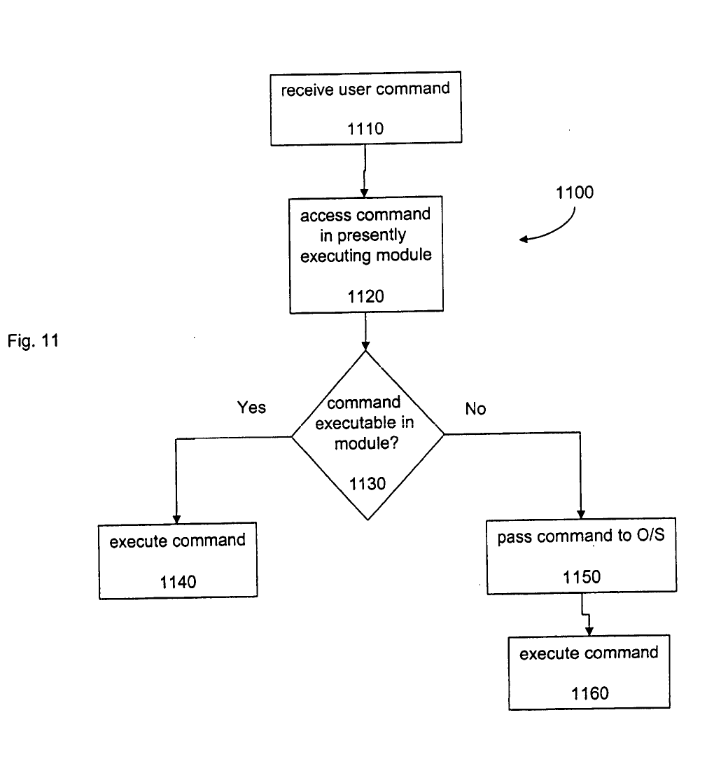

Actual operation of the media player and content file may occur in a variety of ways. FIG. 11 illustrates an alternate embodiment of a process of operating a user interface on a personal device. Process 1100 includes receiving a user command, accessing that command in the present module, determining if the module can execute the command, and either executing the command or passing the command to an operating system for execution.

Process 1100 initiates when a command is received at module 1110. Such a command may involve displaying information, accessing a submenu, or accessing phone-specific functions on a cellular telephone for example. Other personal devices may have similar functions, such as transmission on a two-way pager. At module 1120, the command is accessed in the presently executing software module—the module looks up its information on how to proceed with the command. A determination is made as to whether the command is executable by the current module, or requires access to operating system commands, at module 1130.

If the command may be executed by the presently executing software module (a media player and content file for example), then the command is executed by the software module at module 1140. If the media player or similar software needs access to the operating system, then the command is passed to the operating system at module 1150. This may involve passing along the command and control to the operating system, effectively turning over execution. Alternatively, it may involve a more limited procedure or function call to the operating system with parameters related to the command received from the user. The command will be executed at module 1160, either through a limited use of the operating system or with the operating system in control.

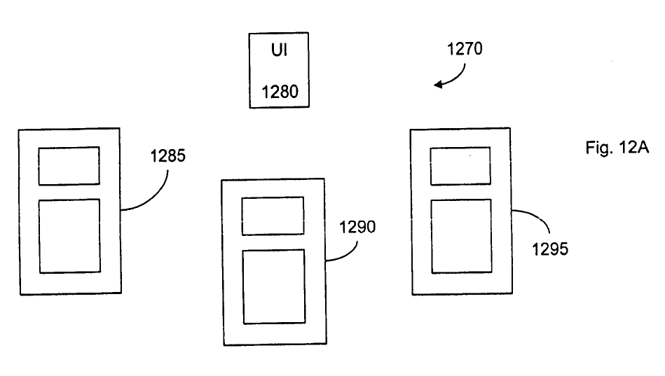

User interfaces for a cellular telephone may be implemented in a device-independent way. FIG. 12A illustrates an embodiment of a user interface which may be used with a variety of embodiments of cellular telephones. System 1270 provides cellular phones of various different types, which use a device-independent user interface.

User interface 1280 is implemented as a content file for a media player. It may then be used on a first cellular telephone 1285, which may be a phone supplied by Nokia, for example. Similarly, user interface 1280 may be used on a second cellular telephone 1290, such as a phone supplied by Motorola, for example. Likewise, user interface 1280 may be used on a third cellular telephone 1295, such as a phone supplied by Palm, for example. In each instance, user interface 1280 is a content file for a media player, and is implemented by the media player on the particular cellular telephone.

A media player and related software may be used on such cellular telephones. FIG. 12B illustrates an embodiment of a cellular telephone and software running on the device. Operating system 1210 is provided on the phone, and interfaces with media player 1220. Various levels of controls may be exposed by operating system 1210. Both operating system 1210 and media player 1220 access local storage 1240, a repository of local data. Media player implements user interface 1230 by using content file 1250. Thus, content file 1250 embodies instructions which allow media player 1220 to provide user interface 1230. Media player 1220 may also interact with applications 1260, such as to obtain phone number information, for example.

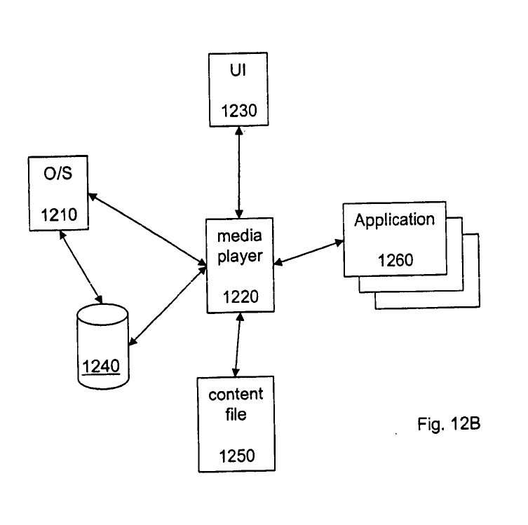

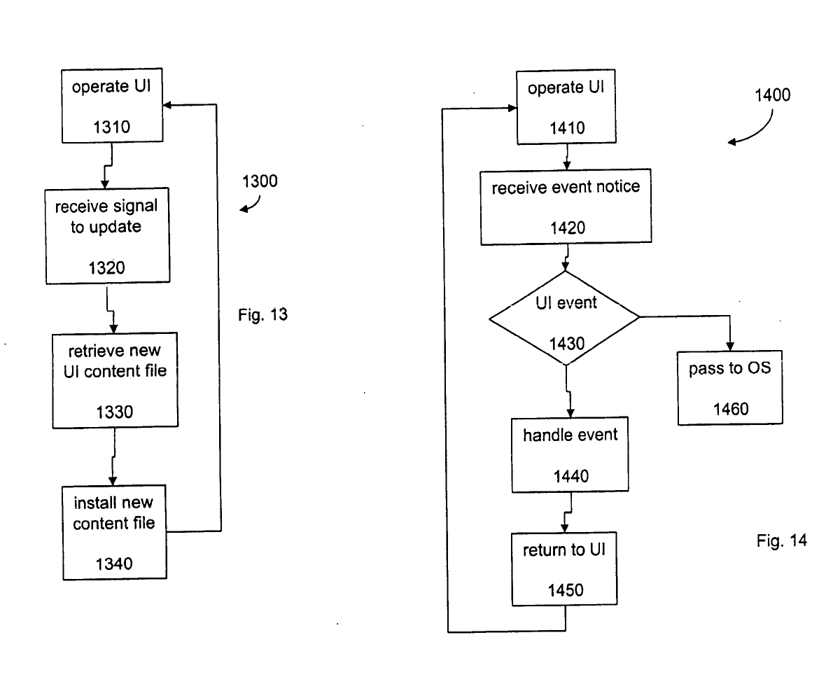

With a user interface which is distinct from the operating system of a cellular telephone, updates and installation may be more flexible than before. FIG. 13 illustrates an embodiment of a process of updating a user interface based on a content file. Process 1300 includes operating a user interface, receiving a signal to update, retrieving a new content file, and installing the new content file.

Process 1300 is illustrated beginning at operation of the user interface at module 1310. A current user interface, implemented with a media player may thus be provided to interact with a user. At module 1320, a signal is received to update the user interface. This may involve an over-the-air signal, or a signal received when a cellular telephone is connected to a docking station or coupled to a wired network, for example. At module 1330, a new content file for the user interface is retrieved from the network. Again, this may be an over-the-air access through the cellular network, or access through a wireline network, for example. At module 1340, the downloaded content file is installed for use on the cellular telephone, thereby updating the user interface.

Such updates may allow for bug fixes. Alternatively, such updates may allow for deployment of later revisions of a user interface. Moreover, such updates may allow for standardized updating of cellular telephones within an organization to maintain standard access operation, or to maintain branding and advertising, for example.

With a media player operating on a cellular telephone, handling of interrupts may be necessary. For example, an incoming call may generate an interrupt. It may be useful for the media player to handle this interrupt, rather than ungracefully exiting in favor of the operating system. FIG. 14 illustrates an embodiment of a process of interrupting a media player on a cellular telephone. Process 1400 includes operating the user interface, receiving an event notice, determining if the event is a user interface event, handling the event by the media player, returning to the user interface, or passing the event to the operating system.

At module 1410, the user interface is operated normally by the cellular telephone in interacting with the user. Thus includes running the media player in conjunction with the content file. At module 1420, an event notice is received by the media player, indicating an event should interrupt the player. At module 1430, a determination is made as to whether the event is a user interface event or not.

If the event is a user interface event, such as selection of an option through a physical user interface, the event may be handled at module 1440 by the user interface content file and the media player. The process then returns to the user interface at module 1450. If the event is not to be handled by the user interface, then at module 1460, the process is passed to the operating system for handling of the event. For example, a shutdown event may require the operating system to take over. At this point, the operating system may later invoke the media player to provide the user interface again, after the event is handled.

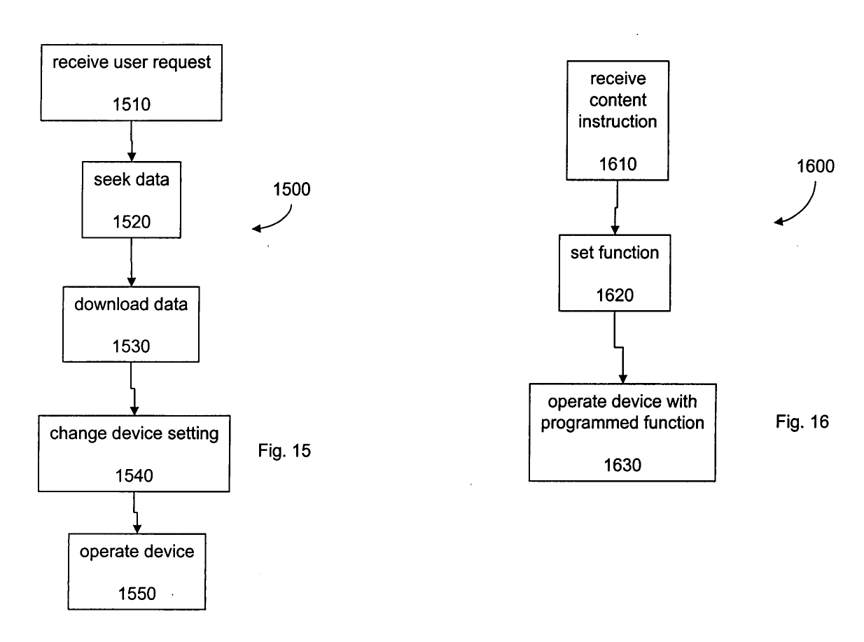

As a user interacts with a cellular telephone, personalization is likely to occur. FIG. 15 illustrates an embodiment of a process of retrieving data and setting data on a cellular telephone. Thus, a user may choose to install new ringtones or other audible tones, or may choose to install a picture of a loved one, for example. The process 1500 includes receiving a user request, seeking the relevant data, downloading the data, changing the device setting and operating the device.

The process 1500 is illustrated as beginning at module 1510, with a user request to install data. At module 1520, the data is sought by the cellular telephone, such as over a wireless network (e.g. cellular network or Bluetooth) or over a wire connection to another device or a network. At module 1530, with the data to be installed found, the data is downloaded to the cellular telephone. At module 1540, the data is set for the appropriate setting of the phone. Thus, a ringtone or other alert may be set, or a background may be changed, responsive to a user request. This setting process/operation may include accessing operating system functions, in some embodiments. At module 1550, the phone is operated with the new setting.

Just as features such as a ringtone may be set on a cellular telephone, so too may function keys or other keys on the phone keyboard. FIG. 16 illustrates an embodiment of a process of setting a function key on a cellular telephone. Process 1600 includes receiving the content instruction(s) or related information, setting the function indicated, and operating the device (telephone) with the newly set function.

At module 1610, process 1600 initiates with a content instruction(s) to set a function for some but not all users, for example. At module 1620, the function is set on the phone in question, allowing for use of that function in the normal course of operations. Note that such setting may require a relatively robust address used over the internet as a matter of course. At module 1630, the cellular phone is operated, with the newly set function included.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Moreover, features of one embodiment may be incorporated into other embodiments, even where those features are not described together in a single embodiment within the present document. While embodiments described herein are intended to be exemplary, these embodiments provide examples of embodiments of the present invention.

What is claimed is:

1. A method, comprising:
presenting a user interface to a user on a cellular telephone by operating a media player with a content file;
receiving user commands;
and
translating the user commands to device specific commands in the media player responsive to the content file.

2. The method of claim 1, further comprising:
accessing a function of the cellular telephone responsive to a user command.

3. The method of claim 2, further comprising:
accessing local information of the cellular telephone responsive to a user command.

4. The method of claim 3, further comprising:
operating the cellular telephone in conjunction with presenting the user interface.

5. The method of claim 4, wherein:
operating the cellular telephone includes initiating communication.

6. The method of claim 4, wherein:
operating the cellular telephone includes receiving communication.

7. The method of claim 3, wherein:
accessing local information includes accessing a local phone book of the cellular telephone.

8. The method of claim 3, wherein:
accessing local information includes accessing local settings of the cellular telephone.

9. The method of claim 8, wherein:
accessing local settings further includes changing a ring tone of the cellular telephone.

10. The method of claim 8, wherein:
accessing local settings further includes changing a backlight time of the cellular telephone.

11. The method of claim 8, wherein:
accessing local settings further includes changing a volume setting of the cellular telephone.

12. The method of claim 8, wherein:
accessing local settings further includes changing a background of the cellular telephone.

13. The method of claim 4, wherein:
accessing local information includes storing local information.

14. The method of claim 13, wherein:
storing local information includes one or more of the group consisting of:
storing phone numbers,
storing names,
and
storing calendar data.

15. The method of claim 1, wherein:
the method is executed by a processor responsive to instructions embodied in a machine-readable medium.

16. A system, comprising:
a cellular telephone including:
a processor;
a display coupled to the processor;
a network interface coupled to the processor;
a local storage medium coupled to the processor;
a media player embodied in the local storage medium;
an operating system embodied in the local storage medium;
and
a user interface embodied as a content file for the media player in the local storage medium, the user interface to receive commands from a user, the media player to translate the commands from the user into commands to the cellular telephone.

17. The system of claim 16, wherein:
the user interface is to access settings of the cellular telephone and update settings of the cellular telephone responsive to user commands.

18. The system of claim 16, wherein:
the user interface is to access local information of the cellular telephone responsive to user commands.

19. The system of claim 16, wherein:
the user interface is to update local information of the cellular telephone responsive to user commands.

20. The system of claim 16, further comprising:
a user input module coupled to the processor.

21. The system of claim 16, further comprising:
means for providing user input to the user interface.

22. A method, comprising:
presenting a user interface to a user on a cellular telephone by operating a media player with a content file;
receiving user commands;
and
translating the user commands to device specific commands in the media player responsive to the content file;
accessing a function of the cellular telephone responsive to a user command;
accessing local information of the cellular telephone responsive to a user command.
and
storing local information.

23. The method of claim 22, further comprising:
initiating communication.

24. The method of claim 22, further comprising
receiving communication.
